(19) United States
(12) Patent Application Publication
(10) Pub. No.: US 2023/0383965 A1
(43) Pub. Date: Nov. 30, 2023

(54) DEVICE FOR PURIFYING AND HUMIDIFYING AIR

(71) Applicant: Rinat Saitov, Moscow (RU)

(72) Inventor: Rinat Saitov, Moscow (RU)

(21) Appl. No.: 18/249,912

(22) PCT Filed: Oct. 23, 2020
(86) PCT No.: PCT/RU2020/000571

§ 371 Date: Apr. 20, 2023

(30) Foreign Application Priority Data
Oct. 23, 2020 (WO) PCT/RU2020/000571

(51) Int. Cl. F24F 6/12; F24F 8/158; F24F 8/22; F24F 8/30; F24F 8/50; F24F 13/28

(52) U.S. Cl. CPC F24F 6/12; F24F 8/158; F24F 8/22; F24F 8/30; F24F 8/50; F24F 13/28

(57) ABSTRACT

The invention relates to systems for preparing air and can be used to purify and humidify air in residential, office, industrial, medical and other premises. The purpose of the claimed invention is achieved by a device for purifying and humidifying air comprising a housing with air intake openings in the lower part and air outlet openings in the upper part, and further comprising an air intake and purification chamber with at least one high-efficiency filter disposed opposite the air intake openings, a fan to create an air flow, a humidification chamber equipped with an ultrasound membrane, and a water tank with an opening to supply water to the humidification chamber.

### CROSS-REFERENCE TO RELATED APPLICATIONS

This application is the U.S. national phase of PCT Application No. PCT/RU2020/000571, filed Oct. 23, 2020, the entire contents of which are incorporated herein by reference.

### TECHNICAL FIELD OF INVENTION

The invention relates to air treatment systems and can be used to purify and humidify air in residential, office, industrial, medical and other premises.

### PRIOR ART

Additional air purification and humidification is currently a hot topic. Purifying the air from harmful impurities and unpleasant odors, removing allergens, bacteria, pollen and viruses makes the air healthier and prevents the spread of infection. Air humidification prevents problems associated with dry air, such as irritation of the mucous membranes of the eyes and upper respiratory tract and reduction of the protective functions of the skin and body as a whole.

It is known to use air scrubbers to purify and humidify the air. This type of devices purifies the air by removing only the large particles, uh as dust and mechanical impurities, but does not remove the smallest particles, such as household dust, allergens, bacteria and viruses.

A combined ionic air filter and humidifier device comprising an ionic air filter, a humidifier, a humidifier manifold, and at least one fan for sucking air through the ionic air filter and directing at least part of the filtered ionized air into the filter inlet of the humidifier manifold is known in the art (WO/2015/143129, B03C3/36, published on 24 Sep. 2015).

This device has a shortcoming of uneven distribution of vapor in the room—there is an excessively humid area around the device, while the air in the rest of the room is insufficiently humidified.

### SUMMARY OF THE INVENTION

The invention solves the problem of purifying and humidifying air without the shortcomings of known devices expands the range of devices useful for this purpose.

The purpose of the claimed invention is to ensure uniform filling of a room with purified and humidified air.

The purpose of the claimed invention is achieved by a device for purifying and humidifying air comprising a housing with air intake openings in the lower part and air outlet openings in the upper part, and further comprising an air intake and purification chamber with at least one high-efficiency filter disposed opposite the air intake openings, a fan to create an air flow, a humidification chamber equipped with an ultrasound membrane, and a water tank with an opening to supply water to the humidification chamber.

The air intake and purification chamber preferably contains at least one coarse air filter disposed opposite the at least one air intake opening.

The air intake and purification chamber preferably contains at least one carbon filter disposed in line with the at least one high-efficiency filer.

The high efficiency filter and the carbon filter should be preferably annular or flat.

The water tank outlet preferably contains a flow-through filter. The flow-through filter is preferably designed to purify water from chlorine, hardness salts, and metals at a rate of at least 150 ml/hr.

The flow-through filter is preferably designed to incorporate activated carbon to soften and effectively purify the liquid from contaminants.

The flow-through filter is preferably designed to incorporate ion-exchange resin to soften and effectively purify the liquid from contaminants.

The air outlet openings are preferably designed as a grid with inclined blades to create a swirling air flow.

The high efficiency filter is preferably a HEPA filter.

The air intake and purification chamber preferably contains a UV lamp.

An airflow separator should be preferably installed at the base of the fan to direct at least part of the filtered air into the humidification chamber.

The air intake openings should be preferably disposed on the bottom portion of the housing or on the side of the lower portion of the housing.

The fan should be preferably designed to generate an air flow of at least 150 m³/hour.

The ultrasonic membrane should be preferably designed to humidify air with a capacity of at least 150 ml/hour.

The water tank outlet should preferably contain a float mechanism to regulate the amount of liquid flowing from the tank into the humidification chamber.

The device should preferably contain an ionizer for additional air purification, placed opposite the humidification chamber.

The upper portion of the housing of the device should preferably contain a container for aromatic oils.

The water tank should preferably be designed with a volume of at least 1 liter.

### BRIEF DESCRIPTION OF THE FIGURES

This disclosure is illustrated by way of example and not limitation in the figures of the accompanying drawings, in which like references indicate similar elements, and in which:

FIG. 1 shows a general view of the device for purifying and humidifying air.

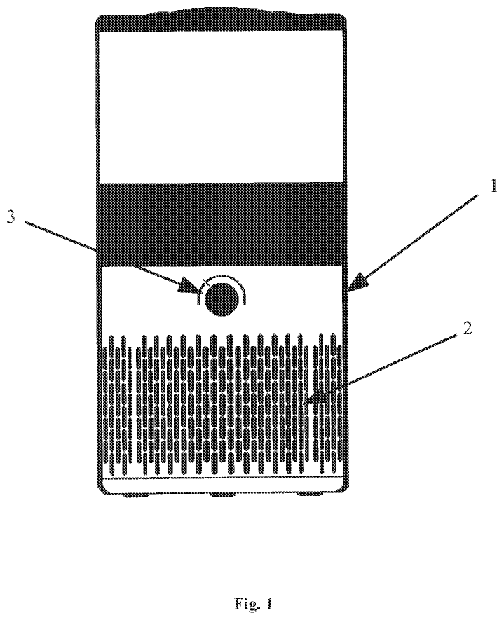

FIG. 2 shows a cross-section of the device for purifying and humidifying air.

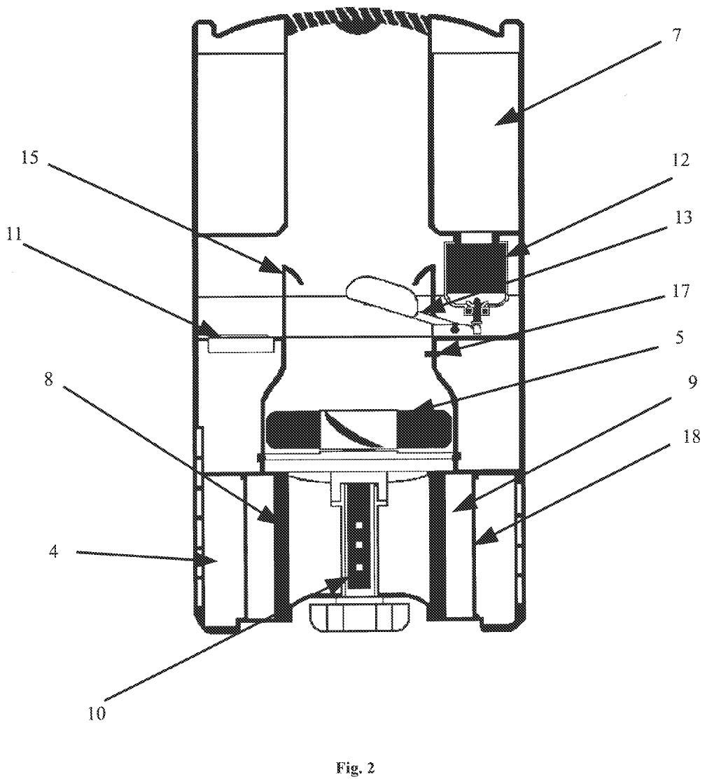

FIG. 3 shows a top view of an embodiment of the device for purifying and humidifying air.

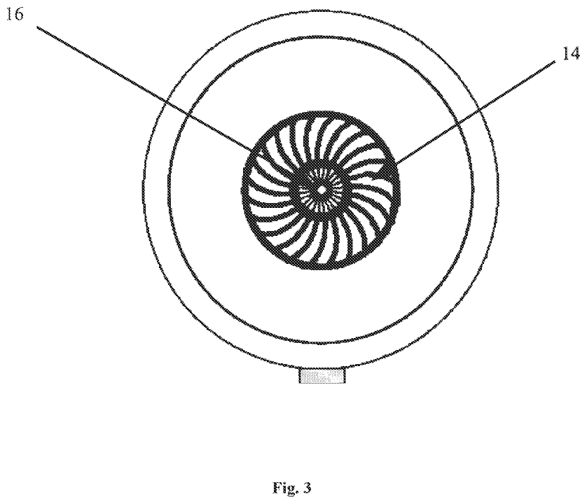

FIG. 4 shows an embodiment of the device for purifying and humidifying air with annular filters.

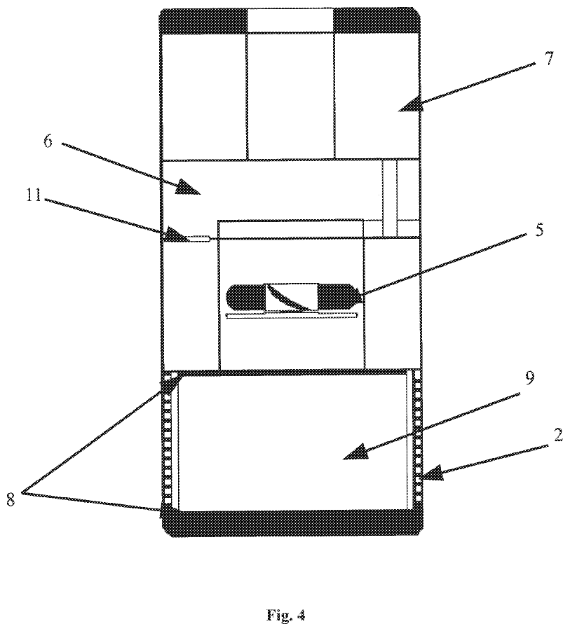

FIG. 5 shows an embodiment of the device for purifying and humidifying air with flat filters.

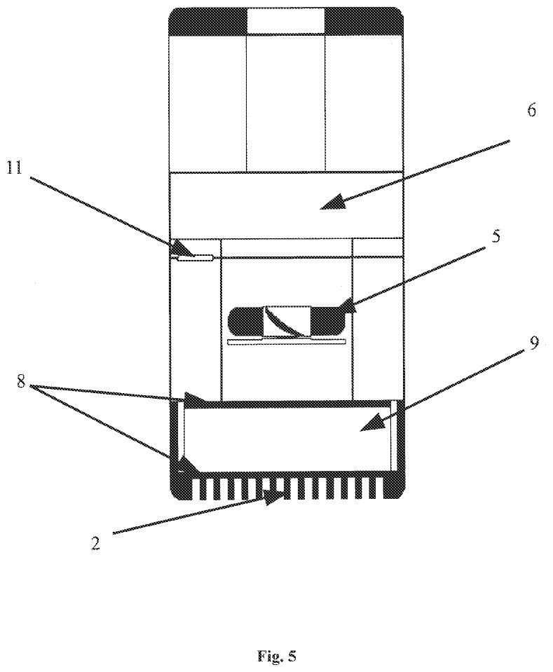

FIG. 6 shows an embodiment of the device for purifying and humidifying air with air intake openings disposed on the side of the lower part of the housing.

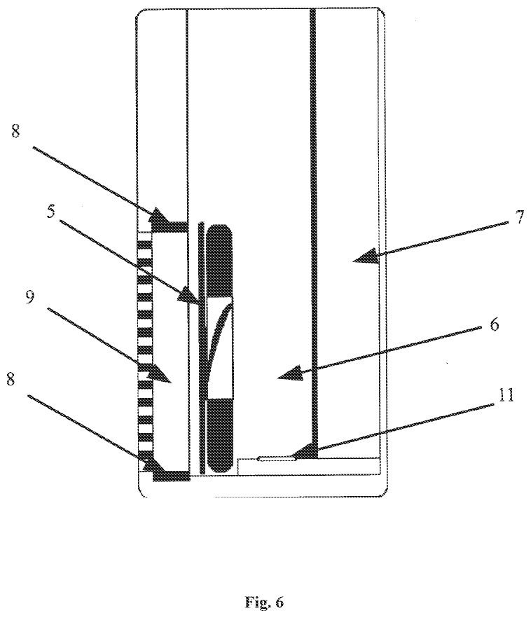

### DETAILED DESCRIPTION

In a preferred embodiment, the device consists of vertically elongated housing 1 having an upper portion, a lower portion and side portions. Housing 1 incorporates oblong air intake openings 2. Air intake openings 2 are disposed on the bottom portion of housing 1 or on the side of the lower portion of housing 1. In another embodiment, air intake openings 2 can be disposed at the bottom of housing 1.

On the front panel, housing 1 includes knob 3 to turn the device on and to regulate power of the device. The upper portion of housing 1 contains at least one air outlet opening 14. Air outlet openings 14 preferably comprise a grid with inclined blades to create a swirling air flow. The upper portion of housing 1 can be provided with a container for aromatic oils 16 for aromatherapy.

Housing 1 contains air intake and purification chamber 4, fan 5, humidification chamber 6 and water tank 7.

Air intake and purification chamber 4 is disposed inside housing 1 in its lower portion. Air intake and purification chamber 4 is designed with high-efficiency filter 9 disposed opposite air intake openings 2, which purifies the air passing through with maximum efficiency. High efficiency filter 9 is designed to purify the air from the smallest particles with an efficiency of at least 85%, preferably not less than 99.95%, and can be selected from EPA, HEPA and ULPA filter groups. High efficiency filter 9, preferably a HEPA filter, can be annular or flat. Air intake and purification chamber 4 can contain carbon filter 8 arranged in line with a high efficiency filter 9. Carbon filter 8 is designed to purify the air from odors, smoke, volatiles and approximate to that state of organic compounds. Air intake and purification chamber 4 can contain UV lamp 10 for additional air disinfection. Air intake and purification chamber 4 can contain a coarse air filter, disposed opposite the air intake openings. The filters in the air intake and purification chamber 4 can be annular or flat.

Fan 5 is disposed in line with air intake and purification chamber 4, on top or to the side of it. Fan 5 is designed to create an air flow of at least 150 m³/hour, preferably not less than 250 m³/hour, which blows air through the filters. An air flow separator 15 can be installed downstream from fan 5 to direct a portion of the air to humidification chamber 6.

Ionizer 17 for additional air purification can be installed downstream of fan 5 and upstream of humidification chamber 6 inside housing 1.

Humidification chamber 6 is disposed downstream of fan 5 inside housing 1. An ultrasonic membrane 11 with a high-frequency vibration feature, which separates incoming water into finely dispersed particles, is disposed at the bottom of chamber 6. Ultrasonic membrane 11 is designed to humidify air with a capacity of at least 150 ml/hour, preferably at least 350 ml/hour.

Water tank 7 is disposed in the upper portion of housing 1. In another embodiment, water tank 7 can be disposed on the side of housing 1. Water tank 7 has a volume of at least 1 liter, preferably at least 4 liters. Water tank outlet 7 can contain flow-through filter 12, designed to purify water from chlorine, hardness, and metals at a rate of at least 150 ml/hr, preferably at least 200 ml/hr. Flow-through filter 12 can be designed with activated carbon and ion-exchange resin to soften and effectively purify the liquid from contaminants. Water tank outlet 7 can contain float mechanism 13, which regulates the amount of liquid flowing into humidification chamber 6. Float mechanism 13 is preferably provided to maintain the liquid level in the water tank 7 above ultrasonic diaphragm 11 at about 30 mm.

A method for the use of the device according to an embodiment of the invention is as follows: The user pushes on the trigger mechanism on knob 3. Fan 5 generates air intake through air intake openings 2 and creates continued air flow. The air enters air intake and purification chamber 4 through air intake openings 2. Air inside purification chamber 4 may be purified with a coarse air filter. High-efficiency filter 9 captures the smallest particles and purifies the air. Carbon filter 8 removes smoke, harmful gases and odor from the air. Also, the air can be additionally purified from harmful microorganisms and fungus with UV lamp 10. Part of the air flow is separated by air flow separator 15 and directed to humidification chamber 6, where it mixes with the water vapor from the liquid from water tank 7 created by ultrasonic membrane 11, to create humidified air. The humidified air enters the main air channel and exits the device through air outlet openings 14.

1. A device for purifying and humidifying air comprising
a housing having an upper portion, a lower portion and side portions,
a plurality of air intake openings disposed in the lower portion of the housing,
a plurality of air outlet openings disposed in the upper portion of the housing,
a purification chamber, said purification chamber including at least one high-efficiency filter disposed opposite the at least one air intake opening,
a fan,
a humidification chamber, said humidification chamber including at least one ultrasound membrane, and
a water tank with at least one outlet opening to supply water to the humidification chamber.

2. The device of claim 1, wherein at least one coarse air filter is disposed opposite the at least one air intake opening in the purification chamber.

3. The device of claim 1, wherein at least one carbon filter is arranged in line with the at least one high-efficiency filter.

4. The device of claim 3, wherein the high efficiency filter and the carbon filter are annular or flat.

5. The device of claim 1, wherein a flow-through filter is disposed in the water tank outlet.

6. The device of claim 5, wherein the flow-through filter has a flow rate of at least 150 ml/hr.

7. The device of claim 5, wherein the flow-through filter comprises activated carbon.

8. The device of claim 5, wherein the flow-through filter comprises ion-exchange resin.

9. The device of claim 1, wherein the air outlet openings comprise a grid with inclined blades.

10. The device of claim 1, wherein the high efficiency filter is a HEPA filter.

11. The device of claim 1, wherein a UV lamp is disposed in the air intake and purification chamber

12. The device of claim 1, wherein an airflow separator is disposed at the base of the fan.

13. The device of claim 1, wherein the air intake openings are disposed on the bottom portion of the housing or on the side of the lower portion of the housing.

14. The device of claim 1, wherein the fan generates an air flow of at least 150 m³/hour.

15. The device of claim 1, wherein the ultrasonic membrane is designed to humidify air with a capacity of at least 150 ml/hour.

16. The device of claim 1, wherein a float mechanism is disposed in the water tank.

17. The device of claim 1, wherein an ionizer is disposed in the purification chamber.

18. The device of claim 1, wherein a container for aromatic oils is disposed in the upper portion of the housing.

19. The device of claim 1, wherein the water tank has a volume of at least 1 liter.
